(19) United States
(12) Patent Application Publication
(10) Pub. No.: US 2008/0193287 A1
(43) Pub. Date: Aug. 14, 2008

(54) HOUSING, FAN DEVICE, MOLD AND METHOD

(75) Inventors: MAKOTO KOBAYASHI, KYOTO (JP); TAKAHIRO KIKUICHI, KYOTO (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: NIDEC CORPORATION, KYOTO (JP)

(21) Appl. No.: 12/016,210

(22) Filed: Jan. 18, 2008

(30) Foreign Application Priority Data
Jan. 18, 2007 (JP) 2007-009500

(51) Int. Cl. F04D 29/44; B29C 39/00

(52) U.S. Cl. 415/208.2; 415/211.2; 425/451.9; 264/299

(57) ABSTRACT

There is provided a fan device with improved performance such as a lower noise level and a higher strength. Such a fan device (11) includes an impeller (12) that has a plurality of rotating blades rotating to take in and exhaust air in an axial direction, a motor that drives the impeller, an external frame member (15) that houses therein the impeller, a support member (16) that is disposed within the external frame member and supports the motor, and a plurality of stator blades (17) that connect the external frame member with the support member and have a wing-like shape in a cross-section in the axial direction. At least in a partial section of each stator blade in a radial direction of the fan device, an angle at which each stator blade is tilted with respect to the axial direction decreases in such a manner that the angle is smaller at an outer side of the fan device in the radial direction than at an inner side of the fan device in the radial direction.

### CROSS-REFERENCE TO RELATED APPLICATION

This patent application claims priority from Japanese Patent Application No. 2007-009500 filed on Jan. 18, 2007, the contents of which are incorporated herein by reference.

### BACKGROUND

1. Technical Field

The present invention relates to a housing, a fan device, a mold, and a housing manufacturing method.

2. Description of the Related Art

In recent years, there is an increasing trend of higher density and smaller size in the field of electronic apparatuses such as personal computers. Accordingly, the electronic apparatuses tend to generate more heat. Here, it is required to dissipate the heat from the electronic apparatuses to the outside in order to prevent the performance of the electronic apparatuses from deteriorating. The heat dissipation is generally carried out by heat dissipating means realized by a cooling fan.

Generally speaking, a fan has the maximum static pressure of lower than or equal to 10 kPa, a blower has the maximum static pressure of 10 kPa to 100 kPa, and a compressor has the maximum static pressure exceeding 100 kPa. Irrespective of the maximum static pressure, however, a centrifugal fan may be referred to as a blower. In the following description of the present application, the term “fan devices” refers to devices having the maximum static pressure of lower than or equal to 10 kPa, including the centrifugal fan.

There are two different methods for dissipating heat with the use of a fan. According to one of the methods, heat is dissipated based on the exhaust of the air within an electronic apparatus which is carried out with the use of a fan. To be specific, the fan causes the air to circulate within the electronic apparatus so as to dissipate the heat to the outside. According to the other method, an electronic apparatus is cooled down by directly applying an air flow against a member required to be cooled down. An example of the fan used in the latter method is a fan provided on a heat sink designed for cooling down a CPU. Such cooling fans come in a variety of types, and include axial-flow fan devices.

The fan device of this type is constituted by rotating blades and a housing, and exhausts in the axial direction the air which it has taken in. Referring to this type, the rotation of the rotating blades adds a centrifugal component (a component extending outward in the radial direction) to the exhaust air flow. Therefore, the air flow at the air outlet is likely to expand outward in the radial direction. Note here that the radial direction refers to the direction orthogonal to the axial direction. For the reason stated above, when positioned so as to abut the air outlet of the fan device in the axial direction, the member required to be cooled down may not be able to receive a sufficient amount of air flow. This tends to deteriorate the cooling characteristics of the fan device.

In addition to having the above-mentioned cooling function, a cooling fan device mounted on an electronic apparatus is required to have low-noise characteristics and adequate strength. Specifically speaking, there has been recently a demand for reducing the noise of the cooling fans mounted on, in particular, personal computers and automobiles, and a low-noise fan device is therefore desired. In addition, a fan device is required to have sufficient strength for the environment in which the fan device is to be utilized.

To satisfy the above-mentioned demands, there has been proposed a fan device having an air guiding member provided at one of an air inlet and an air outlet as disclosed in Unexamined Japanese Patent Application Publications No. 2006-63972 and No. 2006-63968. The air guiding member adjusts the air flow. When the air guiding member is disposed at the air outlet, the centrifugal component of the air flow which extends outward in the radial direction can be changed into the axial component. In other words, the air guiding member can produce an air flow concentrating effect. When the air guiding member is disposed at the air inlet, the air flow to be taken in by the fan device is aligned. Therefore, the noise to be generated can be reduced when compared with the case where the air guiding member is not provided.

Here, one of the factors which cause the fan device to generate noise is the disturbance of the air flow which is attributed to the extra portion formed as a result of the injection molding process at the connection portion between the air guiding members (stator blades) and the external frame member of the housing. Referring to the fan device of this type, the stator blades and the housing are formed by the injection molding process as a single integrated member. The injection molding process forms an extra portion 5 at a connection portion 4 between a stator blade 1 and an external frame member 3 of a housing 2, as shown in FIG. 6. Colliding with the extra portion 5, the air flow is disturbed. The disturbance generates a great deal of noise.

The following describes the reason why the above-mentioned extra portion 5 is formed. The mold used for the injection molding process includes an upper mold and a lower mold. The upper and lower molds are positioned so as to oppose each other with the axis 6 of the fan device being sandwiched therebetween, and then caused to come in contact with each other. In this way, a space is created within the molds. A resin which has been heated and thus melted is subsequently injected into the created space. Once the resin cools down and cures, the molds are separated from each other. Here, note that the inner surface of each of the air outlet and inlet openings of the external frame member 3 of the housing 2 may have an expansion portion 3a formed therein in order to, for example, stabilize the air flow. In the expansion portion 3a, the inner surface of the opening opens outward in the radial direction in such a manner that the diameter of the opening is larger at the open end of the opening. In this case, when the housing 2 is seen in the axial direction 6, a blind spot (the portion 7) is created at the connection portion 4 between the stator blade 1 and the expansion portion 3a formed in the inner surface of the external frame member 3 of the housing 2. During the injection molding process, a melted resin is also injected into the blind spot portion 7. The resin similarly cools down and cures, to form the extra portion 5. To prevent the extra portion 5 from being formed, the undercutting process may be adopted in the fan device forming method. This forming method, however, requires a mold having a complicated shape and a larger number of steps, thereby significantly increasing the designing time and manufacturing cost. Also, this forming method poses a problem of a lower dimensional accuracy.

In order that the fan device has sufficient strength, the stator blades are also required to have adequate strength (rigidity and other properties). Here, a conventional fan device is configured in such a manner that the angle at which each stator blade is tilted with respect to the axial direction is set substantially constant over the entire length of the fan device in the radial direction. This means that the bending rigidity of each stator blade in terms of the axial direction is substantially constant over the entire length of each stator blade. Therefore, the stress tends to concentrate at the connection portion between each stator blade and the external frame member of the housing. As a result, an external load (an externally applied impact) can easily damage the stator blades.

### SUMMARY

Therefore, it is an object of an aspect of the innovations herein to provide a housing, a fan device, a mold and a housing manufacturing method, which are capable of overcoming the above drawbacks accompanying the related art. The above and other objects can be achieved by combinations described in the independent claims. The dependent claims define further advantageous and exemplary combinations of the innovations herein.

According to the first aspect related to the innovations herein, one exemplary housing may include a housing including a first hole forming portion defining a first hole, a second hole forming portion defining a second hole which is opposite to the first hole, and being substantially symmetrical with respect to an axis of symmetry, a channel forming portion having an inner wall which defines a channel and connecting the first and second hole forming portions to each other, a support member arranged on the axis of symmetry, and a plurality of air guiding portions arranged to connect the support member to at least a portion of the inner wall of the channel forming portion, where the air guiding portions respectively have a plurality of air guiding surfaces capable of guiding air from the first hole forming portion to the second hole forming portion. Here, each of the air guiding surfaces intersects with a cylindrical surface defined as an outer circumferential surface of a cylinder which is centered on the axis of symmetry and which has a radius from a radius of the support member to a radius of the inner wall of the channel forming portion, and an angle of a first line at which one of the air guiding surfaces intersects with the cylindrical surface with respect to the axis is smallest when the one of the air guiding surfaces crosses the cylindrical surface on the inner wall of the channel forming portion.

According to the second aspect related to the innovations herein, one exemplary fan device may include a fan device including the housing as set forth above, an impeller having a plurality of rotating blades rotatable about a rotation axis to create an air flow flowing along the rotation axis, and a motor driving the impeller. Here, the impeller and the motor are accommodated in the housing from the first hole, and the support member supports the motor.

According to the third aspect related to the innovations herein, one exemplary mold may include a mold used for forming a housing having a plurality of air guiding portions. The mold includes a first mold and a second mold to be combined with each other. The first mold includes a substantially columnar first base portion having a top surface which is substantially symmetrical with respect to an axis of symmetry, and a plurality of first protruding portions protruding from the top surface of the first base portion in an axial direction parallel to the axis of symmetry, where the first protruding portions are arranged about the axis of symmetry at substantially regular circumferential intervals and spaced away from the axis of symmetry. Each of the first protruding portions includes a first air-guide forming portion connected to the top surface of the first base portion and a first engaging portion connected to an upper portion of the first air-guide forming portion, the first engaging portion has a first contact surface intersecting with a top surface of a corresponding one of the first protruding portions and being substantially parallel to the axial direction, the first air-guide forming portion has a first curved surface connected to the first contact surface and intersecting with the top surface of the corresponding one of the first protruding portions. The second mold includes a substantially columnar second base portion having a top surface which is substantially symmetrical with respect to another axis of symmetry, and a support-member forming portion arranged along the other axis of symmetry of the second base portion and having a substantially flat top surface, and a plurality of second protruding portions protruding from the top surface of the second base portion along the other axis of symmetry and each being received in a space between adjacent ones of the first protruding portions on the first base portion, where the second protruding portions are connected to the support-member forming portion and arranged about the other axis of symmetry at substantially regular circumferential intervals and spaced away from the other axis of symmetry. Each of the second protruding portions includes a second engaging portion connected to the second base portion and a second air-guide forming portion connected to an upper portion of the second engaging portion, the second engaging portion has a second contact surface intersecting with the top surface of the base portion and being substantially parallel to the other axis of symmetry, and the second air-guide forming portion has a second curved surface connected to the second contact surface and intersecting with a top surface of a corresponding one of the second protruding portions. When the first and second molds are combined with each other with the axes of symmetry of the first and second base portions coincident with each other and the top surface of each of the first protruding portions facing the top surface of each of the second protruding portions, the support-member forming portion of the second mold is received in a space formed near the axes of symmetry by two or more of the first protruding portions; the first contact surface comes into contact with the second contact surface; the top surfaces of the first protruding portions come into contact with the top surfaces of the second protruding portions; and the top surfaces of the second protruding portions come into contact with the top surface of the first base portion, thereby defining a plurality of spaces for forming the air guiding portions of the housing by the first curved surfaces of the first air-guide forming portions and the respective second curved surfaces of the second air-guide forming portions, and an angle, with respect to the axes of symmetry coincident with each other, of a first line at which one of the first curved surfaces intersects with a cylindrical surface as an outer circumferential surface of a cylinder centered about the axes of symmetry, is smallest when a radius of the cylinder is substantially equal to an radius of an outer wall of the first base portion.

According to the fourth aspect related to the innovations herein, one exemplary method may include a method of forming a housing by means of the mold as set forth above. The method includes combining the first and second molds with each other, heating material of the housing, supplying the heated material into a space defined in the combined first and second molds, and separating the combined first and second molds from each other.

According to the fifth aspect related to the innovations herein, one exemplary fan device may include a fan device including an impeller that has a plurality of rotating blades rotating to take in and exhaust air in an axial direction, a motor that drives the impeller, an external frame member that houses therein the impeller, a support member that is provided in the external frame member and supports the motor, and a plurality of stator blades that connects the external frame member to the support member, where the plurality of stator blades have a wing-like shape in a cross-section in the axial direction. Here, at least in a partial section of each stator blade in a radial direction of the fan device, an angle at which each stator blade is tilted with respect to the axial direction decreases in such a manner that the angle is smaller at an outer side of each stator blade in the radial direction than at an inner side. Note that the radial direction represents a direction orthogonal to the axial direction.

### BRIEF DESCRIPTION OF THE DRAWINGS

FIG. 1 is a perspective view illustrating a fan device relating to an embodiment of the present invention.

FIG. 2 is a plan view illustrating the fan device illustrated in FIG. 1.

FIG. 3 is a cross-sectional view illustrating the fan device illustrated in FIG. 1.

FIG. 4 includes cross-sectional views, along a plurality of planes, illustrating a stator blade included in the fan device illustrated in FIG. 1.

FIG. 5 is a cross-sectional view illustrating a modification example of the stator blade included in the fan device illustrated in FIG. 1.

FIG. 6 is used to illustrate an extra portion formed at a connection portion between a stator blade of a fan device and an external frame member.

FIG. 7 illustrates the P-Q characteristics of the fan device relating to the embodiment of the present invention and the P-Q characteristics of a conventional fan device.

FIG. 8A illustrates an example of a lower mold 100 used to form a housing 18.

FIG. 8B illustrates a first protruding portion 150 relating to the present example in detail.

FIG. 9A illustrates an example of an upper mold 200 used to form the housing 18.

FIG. 9B illustrates a second protruding portion 250 relating to the present example in detail.

FIG. 10 illustrates the lower and upper molds 100 and 200 in the state of being combined with each other.

FIG. 11 illustrates examples of a right mold 300 and a left mold 400.

FIG. 12 illustrates the right and left molds 300 and 400 in the state of being combined with each other.

FIG. 13 illustrates how a first air-guide forming portion 120 and a second air-guide forming portion 220 are positioned relative to each other when the lower and upper molds 100 and 200 are separated from each other.

FIG. 14 illustrates a space formed between the first and second air-guide forming portions 120 and 220.

FIG. 15 illustrates a series of steps to form a housing with the use of the four molds 100, 200, 300 and 400.

### DESCRIPTION OF EXEMPLARY EMBODIMENTS

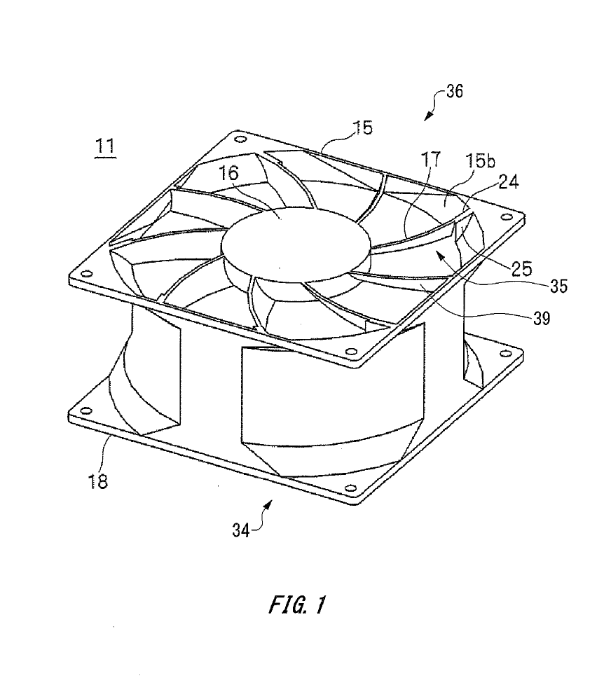

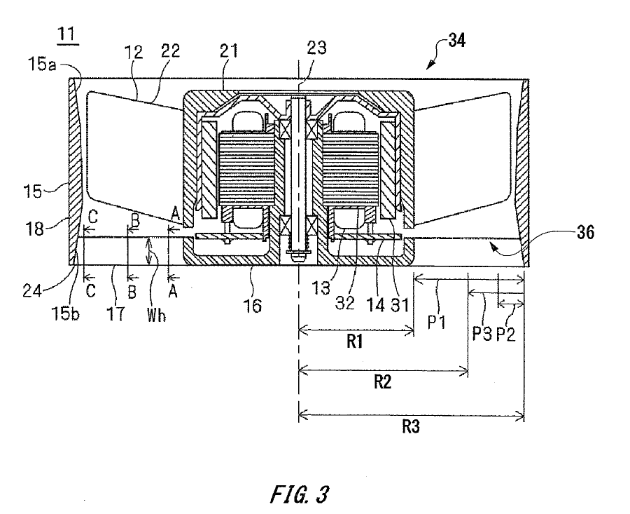

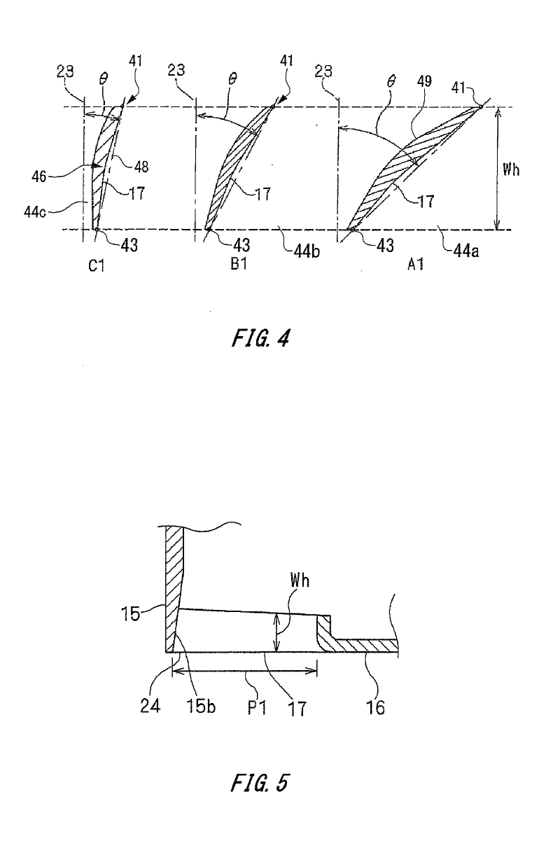

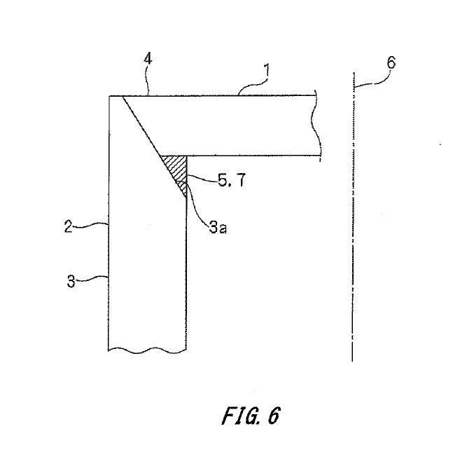

FIGS. 1 to 3 are perspective, plan and cross-sectional views illustrating a fan device relating to an embodiment of the present invention. FIG. 4 includes cross-sectional views, along a plurality of planes, illustrating a stator blade included in the fan device. The cross-sectional shapes assigned with the signs A1, B1 and C1 in FIG. 4 respectively correspond to the cross-sectional shapes of a stator blade 17 obtained when the stator blade 17 is cut along the lines A-A, B-B and C-C shown in FIG. 3. Note that the stator blade 17 is shown as an example of an air guiding portion. In the following description of the present embodiment, the air guiding portion is referred to as the stator blade 17.

As illustrated in FIGS. 1 to 3, the fan device 11 includes therein a housing 18, an impeller 12, a motor 13, and a circuit substrate 14. The housing 18 includes two (first and second) channel forming holes 34 and 36, an external frame member 15, a support member 16, and a plurality of stator blades 17. The first and second channel forming holes 34 and 36 are positioned so as to oppose each other. According to the present example, the first and second channel forming holes 34 and 36 are substantially circular. According to the present example, the external frame member 15, support member 16, and stator blades 17 are formed as a single integrated member made of a resin, which is obtained as a result of the injection molding process explained later. Therefore, the external frame member 15 connects the first and second channel forming holes 34 and 36 to each other. Here, the first and second channel forming holes 34 and 36 are respectively shown as examples of first and second holes. Note that a portion of the housing 18 which defines the first hole corresponds to a first hole forming portion, and that a different portion of the housing 18 which defines the second hole corresponds to a second hole forming portion. The external frame member 15 is shown as an example of a channel forming portion.

According to the present example, the support member 16 is substantially shaped like a circular cylinder. The support member 16 is provided in such a manner that the axis of the circular-cylinder-like support member 16 substantially coincides with the axis of the second channel forming hole 36. The stator blades 17 connect the support member 16 with at least part of the inner wall 35 of the external frame member 15. Each stator blade 17 has an air guiding surface 38 that guides air from the first channel forming hole 34 to the second channel forming hole 36. According to the present example, the plurality of stator blades 17 are arranged, between the support member 16 and the inner wall 35, at substantially equal intervals in such a manner that each stator blade 17 connects the support member 16 and the inner wall 35 to each other.

The impeller 12 includes therein a cup portion 21 that houses therein the motor 13 and a plurality of rotating blades 22 that extend from the cup portion 21 outward in the radial direction. With the rotation of the rotating blades 22, the impeller 12 takes in air in an axis direction 23, and exhausts the air in the axis direction 23. The external frame member 15 is provided so as to surround the impeller 12. The support member 16 is positioned inside the external frame member 15, and supports the motor 13 and the circuit substrate 14. According to the present example, the impeller 12 and the motor 13 are inserted into the housing 18 through the first channel forming hole 34, and the support member 16 supports the motor 13. In this case, the support member 16 and the rotating blades 22 are positioned relative to the housing 18 in such a manner that the respective axes of the first and second channel forming holes 34 and 36, the axis of the support member 16, and the axis of the rotating blades 22 substantially coincide with each other.

The plurality of stator blades 17 are provided so as to radially extend from the support member 16 outward in the radial direction of the fan device 11. Each stator blade 17 has a wing-shaped cross-section (for example, slightly bent cross-section). Each stator blade 17 has an air guiding surface 38 that guides the air from the rotating blades 22 so that the air moves from the first channel forming hole 34 to the second channel forming hole 36 and a surface 39 opposing the air guiding surface 38. According to the present example, the air guiding surface 38 is formed concave, and the surface 39 is formed convex. The air guiding surface 38 and the surface 39 meet each other at the respective edge portions, in other words, at a first edge 40 and a second edge 42. In this way, the air guiding surface 38 and the surface 39 form the wing-shaped cross-section. The stator blades 17 are tilted with respect to the axis direction 23 of the impeller 12 so as to extend in a direction opposite to the direction in which the rotating blades 22 of the impeller 12, which are also tilted with respect to the axial direction 23, extend. The stator blades 17 are bent in such a manner that the direction the convex surfaces 39 of the stator blades 17 face is the same as the rotating direction of the rotating blades 22. The stator blades 17 are arranged in such a manner that, when the second channel forming hole 36 is seen in the axial direction 23, each first edge 40 and the entire surface of each air guiding surface 38 are able to be seen. Since the stator blades 17 are wing-shaped as described above, the cooling air flow generated by the impeller 12 accurately and efficiently concentrates towards the axial center of the fan device 11.

The stator blades 17 having the configuration described above are disposed on the air outlet side relative to the impeller 12 in order to be able to efficiently concentrate the cooling air flow generated by the impeller 12. As a modification example, the stator blades 17 may be disposed on the air inlet side relative to the impeller 12.

The housing 18 has expansion portions 15a and 15b. The expansion portion 15a has a hole formed outside the first channel forming hole 34 in such a manner as to connect to the first channel forming hole 34. The expansion portion 15b has a hole formed outside the second channel forming hole 36 in such a manner as to connect to the second channel forming hole 36. When the housing 18 is seen in the direction orthogonal to the plane in which one of the first and second channel forming holes 34 and 36 is formed, the expansion portions 15a and 15b have a substantially quadrangular shape. The diameter of the hole of each of the expansion portions 15a and 15b increases in such a manner as to be larger on the outer side of the housing 18 in the axial direction than on the inner side. Which is to say, according to the present example, each of the expansion portions 15a and 15b is provided in the four corner portions of the housing 18. In each of the expansion portions 15a and 15b, the inner surface of the housing 18 opens outward in the radial direction like a trumpet (or like a reverse taper shape) in such a manner that the diameter of the expansion portion is larger at the open end of the expansion portion. Such a configuration stabilizes the flow of the air which is taken in through the first channel forming hole 34 and the flow of the air which is exhausted through the second channel forming hole 36. The shape of the opening of each of the expansion portions 15a and 15b gradually changes from the substantially circular shape of a corresponding one of the first and second channel forming holes 34 and 36 into the quadrangular shape, which forms a smooth curved surface. According to the present example, the expansion portions 15a and 15b are substantially shaped like a square.

Here, some of the stator blades 17 extend towards the corner portions of the external frame member 15. The outer end portions, in the radial direction, of these stator blades 17 are connected to the inner surface of the external frame member 15, specifically speaking, to the expansion portion 15b.

The motor 13 is constituted by a rotor magnet 31 that is attached to the inner surface of the impeller 12 and an armature 32 that generates a torque between itself and the rotor magnet 31. The motor 13 is housed within the cup portion 21 that is positioned at the central portion of the impeller 12. The circuit substrate 14 includes a control circuit for controlling the rotation of the motor 13.

The following describes the stator blades 17 and the neighboring constituents relating to the present embodiment. As shown in FIGS. 1 to 4, while the width Wh of each stator blade 17 in the axial direction 23 is kept substantially constant, the angle θ at which each stator blade 17 is tilted with respect to the axial direction 23 decreases in such a manner that the angle θ is smaller on the outer side of the fan device 11 in the radial direction than on the inner side, according to the present embodiment. Note that this configuration is true at least in a partial section of each stator blade 17 in the radial direction of the fan device 11. In other words, when the radius of a (imaginary) circular cylinder that is centered on the axis 23 is varied from the radius of the support member 16 to the radius of the inner wall 35 of the external frame member 15, the angle formed by a line 46 with respect to the axial direction 23 is smallest when the radius is equal to the radius of the inner wall 35. Here, the line 46 is formed where a cylindrical surface defined as the outer circumferential surface of the circular cylinder intersects with at least one air guiding surface 38. In this case, the angle formed by the line 46 with respect to the axial direction 23 can be defined by developing the cylindrical surface into a plane 44. According to the present example, the angle θ represents an angle formed with respect to the axial direction 23 by a straight line 48 connecting together the respective ends 41 and 43 of the line 46. In this case, the ends 41 and 43 are where the cylindrical surface intersects with the first and second edges 40 and 42. Note that, according to the present example, the radius of the above-mentioned circular cylinder is varied within a range from the distance R1 to the distance R3, where R1 indicates the distance between the center of the circular cylinder and the external surface of the support member 16 and R3 indicates the distance between the center of the circular cylinder and the inner wall 35 (see FIG. 3). According to the present example, the line 46 is defined as a line formed at which the cylindrical surface intersects with at least one of the air guiding surfaces 38. Alternatively, however, the line 46 may be defined as a line formed at which a plane in contact with the outer circumferential surface of the circular cylinder intersects with at least one of the air guiding surfaces 38. In this alternative case, the radius of the circular cylinder may be varied while one of the contact points between the outer circumferential surface and the plane moves along one of the first and second edges 40 and 42.

According to another example, the angle θ may be differently defined as the angle formed by a tangent line to the line 46 with respect to the axial direction 23. If such is the case, the angle θ may indicate the angle formed with respect to the axial direction 23 by the tangent line at the end 41 (or the end 43). Alternatively, the angle θ may be defined as the average angle between the angle formed with respect to the axial direction 23 by the tangent line at the end 41 and the angle formed with respect to the axial direction 23 by the tangent line at the end 43. Alternatively, the angle θ may be defined as the average angle among angles each formed with respect to the axial direction 23 by a tangent line to the line 46 at a given point. Alternatively, the angle θ may indicate the angle formed with respect to the axial direction 23 by a tangent line at the midpoint of the axial component (Wh) of the straight line 48. Alternatively, the angle θ may indicate the angle formed with respect to the axial direction 23 by the center line obtained by connecting together the respective ends 41 and 43 in such a manner that the center line has substantially the same distance from the curved lines 46 and 49 which respectively form the upper and lower edges of the wing-shaped cross-section of each stator blade 17.

According to the present example, the stator blades 17 are shaped in the following manner. As the radius of the above-mentioned circular cylinder increases from the support member 16 to the inner wall 35, the angle θ decreases so as to have the smallest value when the radius is at the inner wall 35. According to the present example, when the radius of the above-mentioned circular cylinder varies from the radius of the support member 16 to the radius of the inner wall 35, the length of the axial component of the first line 46 (Wh) is kept constant, where the first line 46 is formed where the cylindrical surface intersects with at least one air guiding surface 38 (see planes 44a, 44b and 44c in FIG. 4). Therefore, over substantially the entire section P1 (see FIG. 3) of each stator blade 17 in the radial direction, while the width Wh of each stator blade 17 in the axial direction 23 is kept substantially constant, the angle θ at which each stator blade 17 is tilted decreases in such a manner that the angle θ is smaller at the outer side of the fan device 11 in the radial direction than at the inner side.

When the angle θ at which each stator blade 17 is tilted is determined, care needs to be taken since the function of the stator blades 17 for adjusting the air flow generated by the rotating blades 22 may be impaired if the angle θ is set at an excessively small value.

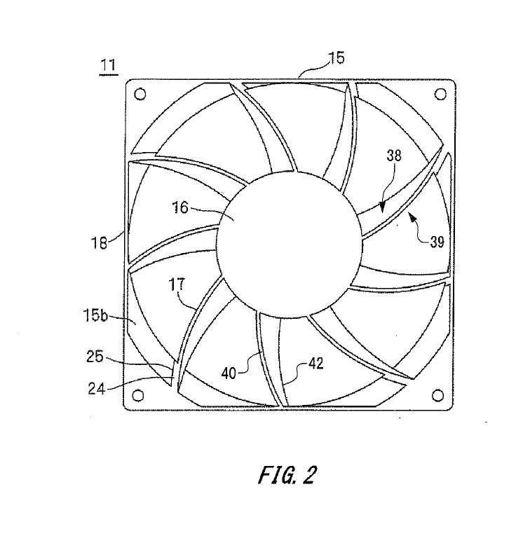

As mentioned earlier, when the external frame member 15 is seen in the axial direction 23, a blind spot is created at the connection portion 24 between each stator blade 17 and the expansion portion 15b formed in the inner surface of the external frame member 15. During the injection molding process, a molten resin is injected into the blind spot, and cures when cooling down. As a result, the extra portion 25 is formed (see FIG. 2). The size of the extra portion 25 depends on the volume of the blind spot created at the connection portion 24 between the expansion portion 15b of the external frame member 15 and each stator blade 17. Here, the volume of the blind spot increases as the angle θ, at the connection portion 24, at which each stator blade 17 is tilted with respect to the axial direction 23 increases. Accordingly, the size of the extra portion 25 similarly increases as the angle θ, at the connection portion 24, at which each stator blade 17 is tilted increases.

In the present example, the angle θ at which each stator blade 17 is tilted with respect to the axial direction 23 gradually decreases in such a manner that the angle θ is smaller at the outer side of the fan device 11 in the radial direction than at the inner side. With such a configuration, the angle θ at which each stator blade 17 is tilted can be made smaller than in the conventional art at the connection portion 24 between each stator blade 17 and the external frame member 15. Therefore, the present example can reduce, when compared with the conventional art, the size of the extra portion 25 formed as a result of the injection molding process at the connection portion 24 between the expansion portion 15b of the external frame member 15 and each stator blade 17. As a result, the present example can reduce the disturbance in the air flow which is attributed to the extra portion 25, thereby lowering the noise.

According to the present example, the angle θ at which each stator blade 17 is tilted gradually decreases in such a manner that the angle θ is smaller at the outer side of the fan device 11 in the radial direction than at the inner side over substantially the entire section P1 of each stator blade 17 in the radial direction. For this reason, while the angle θ at which each stator blade 17 is tilted is varied in a more gradual manner in such a manner that the angle θ is smaller at the outer side of the fan device 11 than at the inner side, the angle θ at which each stator blade 17 is tilted can be made smaller more effectively at the connection portion 24.

In addition, since the angle θ at which each stator blade 17 is tilted can be made smaller than in the conventional art at the connection portion 24 between each stator blade 17 and the external frame member 15 where the stress is likely to concentrate, the present example can prevent the connection portion 24 between each stator blade 17 and the external frame member 15 and other portions from being damaged by external load (an increase in the flow rate during high-speed rotation, an external impact and the like). As a consequence, the present example can improve the strength of the fan device 11.

It is preferable that the number of rotating blades 22 is not the same as the number of stator blades 17 in the present example and that the number of rotating blades 22 is a prime number. By configuring the fan device 11 in such a manner that the number of rotating blades 22 is different from the number of stator blades 17, the present example can reduce the sound that may be created by the resonance between the rotating blades 22 and the stator blades 17.

Since the angle θ at which each stator blade 17 is tilted with respect to the axial direction 23 gradually decreases in such a manner that the angle θ is smaller at the outer side of the fan device 11 in the radial direction than at the inner side in the present embodiment, the fan device 11 can achieve better P-Q characteristics. Note that the P-Q characteristics represent the characteristics of a fan device based on the relation between the static pressure and the flow quantity. To be specific, when a fan device is driven with no load, the fan device operates with the maximum flow quantity. When the fan device 11 is driven with such load that the generated flow quantity is zero, the fan device 11 operates with the maximum static pressure. When a graph is obtained with the X axis representing the value of Q (the flow quantity) and the Y axis representing the value of P (the static pressure), a change in the value of one of P and Q causes the value of the other to vary along the curved line extending from the coordinates (Q_{MAX}, 0) to the coordinates (0, P_{MAX}). The P-Q characteristics refers to the relation between P and Q which is represented by the curved line connecting together the coordinates (Q_{MAX}, 0) and the coordinates (0, P_{MAX}).

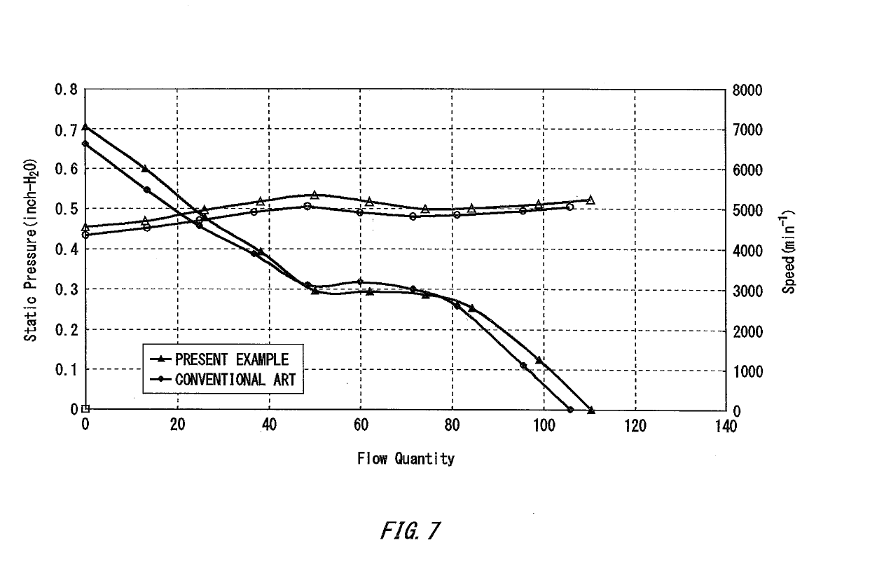

FIG. 7 illustrates the P-Q characteristics of the fan device relating to the present example and the P-Q characteristics of a conventional fan device. As clearly seen from the graph, the fan device relating to the present example achieves a higher maximum static pressure and a larger maximum flow quantity than the conventional fan device when the noise level is set at the same level (50 dB). When the noise level is 50 dB (in the number of rotations, approximately 5,000 min⁻¹), the fan device 11 relating to the present example achieves a maximum static pressure of 175 Pa and a maximum flow quantity of 3.12 m³/min (110 C. F. M) according to simulation.

According to the fan device 11 relating to the present example, the width Wh of each stator blade 17 in the axial direction 23 is maintained substantially constant, the angle at which each stator blade 17 is tilted with respect to the axial direction 23 gradually decreases in such a manner that the angle θ is smaller at the outer side of the fan device 11 in the radial direction than at the inner side, and these configurations are true in the entire section P1 of each stator blade 17. If the width Wh of each stator blade 17 in the axial direction 23 increases, the fan device 11 may inevitably have a large size. This and other drawbacks can be removed by the above configurations relating to the present example.

The following describes a modification example of the fan device 11 relating to the present embodiment.

In the fan device 11 described above, the angle θ at which each stator blade 17 is tilted with respect to the axial direction 23 gradually decreases in such a manner that the angle θ is smaller at the outer side of the fan device 11 in the radial direction than at the inner side, and this configuration is true in substantially the entire section P1 of each stator blade 17 in the radial direction. However, this gradual change in the angle θ at which each stator blade 17 is tilted does not need to be adopted in substantially the entire section P1 of each stator blade 17. As an alternative example, the gradual change in the angle θ at which each stator blade 17 is tilted may be employed in the outmost section of each stator blade 17 in the radial direction (for example, the section P2 shown in FIG. 3). As a further alternative example, the gradual change in the angle θ at which each stator blade 17 is tilted may be employed in the section P3 (see FIG. 3) which is a substantially outer half section of each stator blade 17 in the radial direction.

In the fan device 11 described above, each stator blade 17 may be shaped in the following manner. As the radius of the above-mentioned circular cylinder increases from the radius of the support member 16 to the radius of the inner wall 35, the length of the axial component of the first line 46 that is formed where the cylindrical surface intersects with at least one air guiding surface 38 increases. According to the previously described example, the width Wh of each stator blade 17 in the axial direction 23 is maintained substantially constant in the section P1 within which the angle θ is varied. According to the modification example, however, the width Wh of each stator blade 17 may increase in such a manner that the width Wh is larger at the outer side of each stator blade 17 in the radial direction than at the inner side, in the section P1 within which the angle θ is varied, as shown in FIG. 5. When this configuration is adopted, the angle θ at which each stator blade 17 is tilted with respect to the axial direction 23 can be configured to decrease in such a manner that the angle θ is smaller at the outer side of each stator blade 17 in the radial direction than at the inner side while sufficient amounts are secured for the cross-sectional area of each stator blade 17 and other properties. As a consequence, sufficient strength can be more easily achieved for the stator blades 17.

According to the description made above, the first and second channel forming holes 34 and 36 in the housing 18 have a circular shape, but the present embodiment is not limited to such. For example, the first and second channel forming holes 34 and 36 may have a substantially symmetrical shape. Here, the symmetrical shape may indicate a shape symmetrical with respect to a point, or a shape symmetrical with respect to a line. In more details, the symmetrical shape may be one of an equilateral triangle, a square, a rectangle, a rhombus, an ellipse, and an equilateral polygon. The above description introduces the stator blades 17 having a wing-shaped cross-section as an example of the air guiding portion. However, the shape of the air guiding portion relating to the present invention is not limited to the shape of the stator blades 17 illustrated in the above-mentioned drawings. The air guiding portion may have any shape as long as the air guiding portion has an air guiding surface that can guide air from the first channel forming hole to the second channel forming hole.

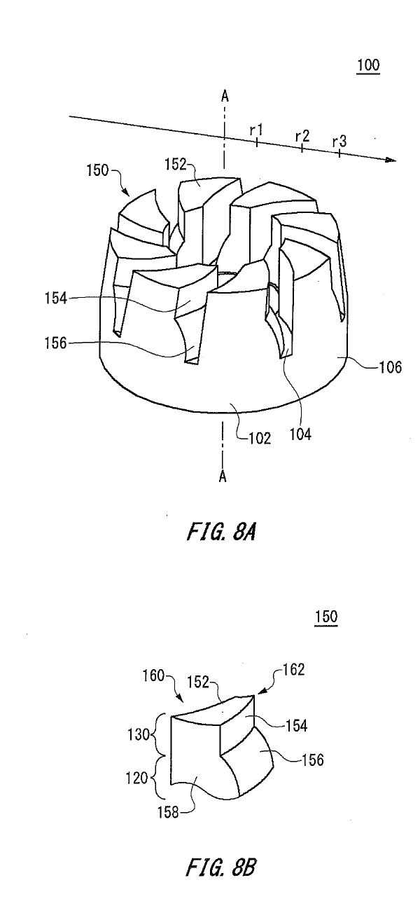

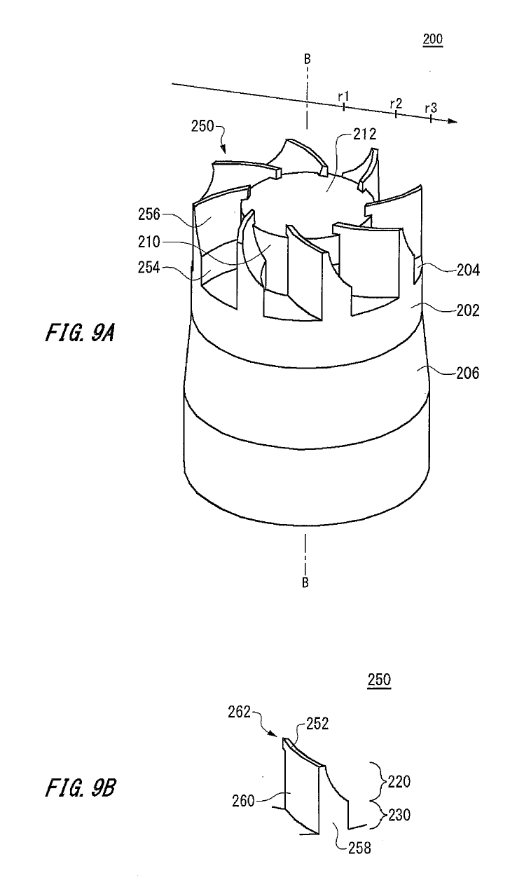

FIG. 8A illustrates an example of a lower mold 100 used to form the housing 18 relating to the present example. FIG. 8B illustrates a first protruding portion 150 relating to the present example in detail. FIG. 9A illustrates an example of an upper mold 200 used to form the housing 18 relating to the present example. FIG. 9B illustrates a second protruding portion 250 relating to the present example in detail. The lower and upper molds 100 and 200 are respectively shown as the examples of first and second molds. According to the present example, the first and second molds are labeled the lower and upper molds 100 and 200. In the drawings, the vertical direction coincides with the direction of the gravitational force. However, the configurations of the first and second molds relating to the present invention are not limited to such an embodiment that the first and second molds are combined with each other in the direction of the gravitational force. For example, when placed on a formation machine, the molds may be combined with each other in the horizontal direction or upside down. Alternatively, the upper mold 200 may be the first mold, and the lower mold 100 may be the second mold.

The lower mold 100 includes a first base portion 102 and a plurality of pillar-like or columnar first protruding portions 150. The first base portion 102 has a top surface 104 and is substantially shaped like a circular cylinder. Each first protruding portion 150 protrudes from the top surface 104 in the direction in which the axis A of the first base portion 102 extends. The plurality of first protruding portions 150 are arranged at substantially equal intervals in the circumference direction with respect to the axis A as the center thereof, and are spaced from the axis A. In this way, the plurality of first protruding portions 150 form a space 110 in the central region in the lower mold 100. The lower mold 100 relating to the present example is not shaped like a perfect circular cylinder, and is alternatively shaped in such a manner that the diameter gradually increases in such a manner as to be larger at one side of the lower mold 100 in the direction in which the axis A extends than at the other side. This configuration is explained later.

Each of the plurality of first protruding portions 150 provided on the top surface 104 includes a first air-guide forming portion 120 and a first engaging portion 130 that is formed on the first air-guide forming portion 120 so as to connect to the first air-guide forming portion 120. Each first protruding portion 150 relating to the present example has a top surface substantially parallel to the top surface 104, and is shaped in such a manner that two pillar-like members each of which has four curved surfaces as the side surfaces thereof (the curved surfaces 154, 158, 160 and 162, and the curved surfaces 156, 158, 160 and 162) are stacked. The top surface 152 of each first protruding portion 150 relating to the present example has a shape like a vane or sector as seen from FIGS. 8A and 8B. Among the curved surfaces mentioned above, the two curved surfaces 158 and 162 opposing each other are defined by the curved surfaces of the circular cylinders which have different radii with respect to the axis A.

For example, the plurality of first protruding portions 150 may be formed by forming grooves in the top surface of a metal member substantially shaped like a circular cylinder. With this method, the first air-guide forming portion 120 is formed in such a manner as to connect to the top surface 104 of the first base portion 102. The first engaging portion 130 has a curved surface 154 that meets the top surface 152 of each first protruding portion 150 and extends substantially in parallel to the axial direction A. The first air-guide forming portion 120 has a first curved surface 156 that is formed in such a manner as to connect to the curved surface 154 and meets the top surface 104 of the first base portion 102. Note that the curved surface 154 is shown as an example of a first contact surface.

The upper mold 200 includes a second base portion 202, a pillar-like support-member forming portion 210, and a plurality of pillar-like second protruding portions 250. The second base portion 202 has a top surface 204 and is substantially shaped like a circular cylinder. The plurality of second protruding portions 250 protrude from the top surface 204 of the second base portion 202 in the direction in which the axis B extends. The support-member forming portion 210 has a flat top surface 212, is substantially shaped like a circular cylinder, and is formed so as to extend in the direction in which the axis B of the second base portion 202 extends. The plurality of second protruding portions 250 are formed so as to connect to the support-member forming portion 210, and arranged at substantially equal intervals in the circumference direction with respect to the axis B. The plurality of second protruding portions 250 are formed in such a manner that each second protruding portion 250 is housed within a space formed between two adjacent first protruding portions 150 provided on the first base portion 102. The upper mold 200 is not shaped like a perfect circular cylinder, but has such a shape that the diameter gradually increases in such a manner that the diameter is larger at one side of the upper mold 200 in the axial direction B than at the other side. This configuration is described later.

According to the present example, each second protruding portion 250 is formed by stacking a pillar-like second engaging portion 230 which has a top surface substantially parallel to the top surface 204 and has as the side surfaces thereof four curved surface (curved surfaces 254, 258, 260 and 262) and a pillar-like second guiding portion forming portion 220 which similarly has a top surface substantially parallel to the top surface 204 and has as the side surfaces thereof four curved surfaces (curved surfaces 256, 258, 260 and 262). Among the curved surfaces mentioned above, the two curved surfaces 258 and 262 opposing each other are defined by the curved surfaces of the circular cylinders which have different radii with respect to the axis B. The second protruding portions 250 are formed so as to have substantially the same height as the first protruding portions 150. Which is to say, the distance from the top surface 204 to the top surface 252 is substantially equal to the distance from the top surface 104 to the top surface 152. Similarly, the second engaging portion 230 is formed so as to have substantially the same height as the first engaging portion 130.

For example, the plurality of second protruding portions 250 may be formed by forming grooves in the top surface of a metal member substantially shaped like a circular cylinder. With this method, each second protruding portion 250 has the second engaging portion 230 that is formed so as to connect to the second base portion 202 and the second air-guide forming portion 220 that is formed on the second engaging portion 230 in such a manner as to connect to the second engaging portion 230. The second engaging portion 230 has a curved surface 254 which meets the top surface of the second base portion 202 and extends substantially in parallel to the axis B of the second base portion 202. The second air-guide forming portion 220 has a second curved surface 256 which connects to the curved surface 254 and meets the top surface of each second protruding portion 250. Note that the curved surface 254 is shown as an example of a second contact surface.

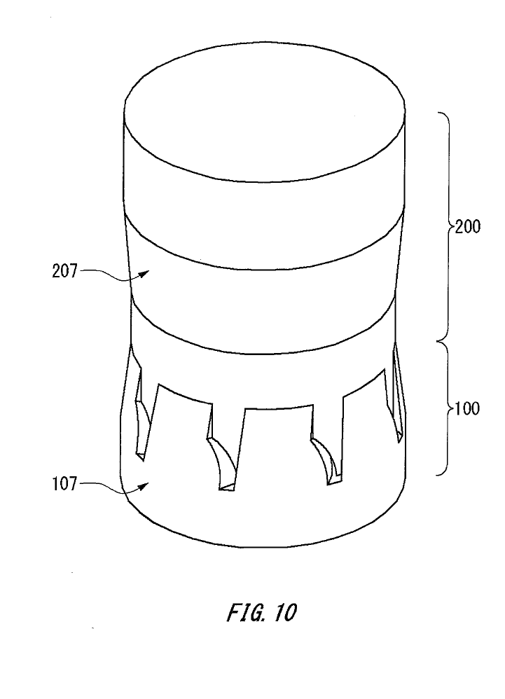

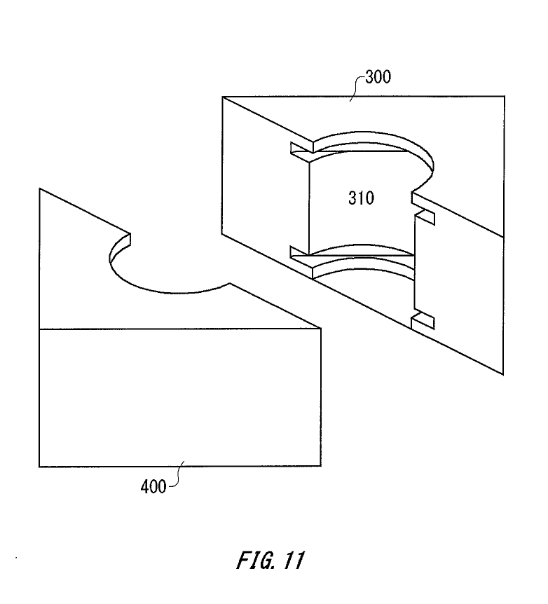

FIG. 10 illustrates the lower and upper molds 100 and 200 in the state of being combined with each other. When the lower and upper molds 100 and 200 are positioned in such a manner that the top surfaces 152 of the first protruding portions 150 oppose the top surfaces 252 of the second protruding portions 250, and then combined with each other in such a manner that the axis A coincides with the axis B, the support-member forming portion 210 is housed within the space 110. In this case, the curved surfaces 154 and 254 move in parallel to the axial direction and abut each other, and the curved surfaces 160 and 260 move in parallel to the axial direction and abut each other. The top surface 152 of each first protruding portion 150 abuts the top surface 204 of the second base portion 202 in the axial direction, and the top surface 252 of each second protruding portion 250 abuts the top surface 104 of the first base portion 102 in the axial direction. As a result of this, the first curved surfaces 156 of the first air-guide forming portions 120 and the second curved surfaces 256 of the second air-guide forming portions 220 together form a plurality of spaces used for forming the plurality of stator blades 17 described with reference to FIGS. 1 to 4.

A portion of the top surface 204 formed between two adjacent second protruding portions 250 abuts each top surface 152 and has substantially the same shape as each top surface 152. Similarly, a portion of the top surface 104 formed between two adjacent first protruding portions 150 abuts each top surface 252 and has substantially the same shape as each top surface 252. The curved surfaces 154 and 254, which abut each other, have substantially the same shape. The curved surface 160 of each first protruding portion 150 and the curved surface 260 of each second protruding portion 250 have substantially the same shape. With the above configurations, the material used to form the housing 18 is reliably and tightly contained within the gap between the combined two molds. The surfaces that abut each other while extending in parallel to the axis direction (for example, the curved surfaces 154 and 254, and the curved surfaces 160 and 260) have curved surfaces substantially parallel to the axes A and B, but these curved surfaces substantially parallel to the axes A and B may be tilted in order to combine the molds smoothly as long as the amount of tilt does not exceed the erection tolerance.

The first base portion 102 has a first expansion portion 107. In the first expansion portion 107, the diameter of the first base portion 102 increases in such a manner that the diameter is larger at the surface of the first base portion 102 which is, in the direction of the axis A, opposite to the top surface 104 than at the top surface 104. The second base portion 202 has a second expansion portion 207. In the second expansion portion 207, the diameter of the second base portion 202 increases in such a manner that the diameter is larger at the surface of the second base portion 202 which is, in the direction of the axis B, opposite to the top surface 204 than at the top surface 204. According to the present example, the first and second expansion portions 107 and 207 are respectively formed in the outer wall 106 of the first base portion 102 and in the outer wall 206 of the second base portion 202.

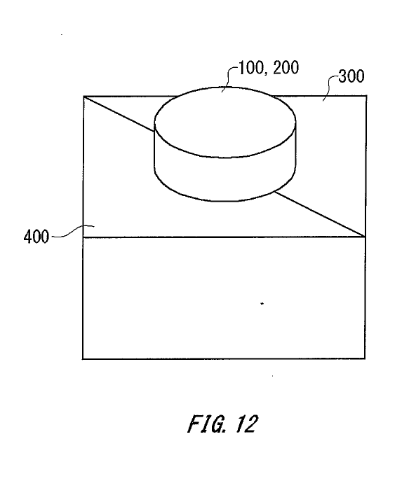

According to the present example, a right mold 300 and a left mold 400 are additionally used. FIG. 11 illustrates, as an example, the right and left molds 300 and 400. The right and left molds 300 and 400 are molds whose shapes are substantially symmetrical to each other. The right and left molds 300 and 400 sandwich therebetween the outer walls 106 and 206 of the lower and upper molds 100 and 200 in the state of being combined with each other. In this way, the four molds are combined with each other. FIG. 12 illustrates the right and left molds 300 and 400 in the state of being combined with each other. The right and left molds 300 and 400 are combined with the lower and upper molds 100 and 200 by holding, at least partially, the first expansion portion 107 in the outer wall 106 and the second expansion portion 207 in the outer wall 206. Note that the right and left molds 300 and 400 are shown as the examples of a third mold and a fourth mold.

A space formed by the inner wall 310 of the right mold 300, the inner wall of the left mold 400 (not shown), and the outer walls 106 and 206 of the combined lower and upper molds 100 and 200 connects to the plurality of spaces formed between the first curved surfaces 156 of the first air-guide forming portions 120 and the second curved surfaces 256 of the second air-guide forming portions 220. The material to form the housing 18 is supplied into the above spaces created by the combined four molds. In this way, the housing 18 described with reference to FIGS. 1 to 4 can be obtained.

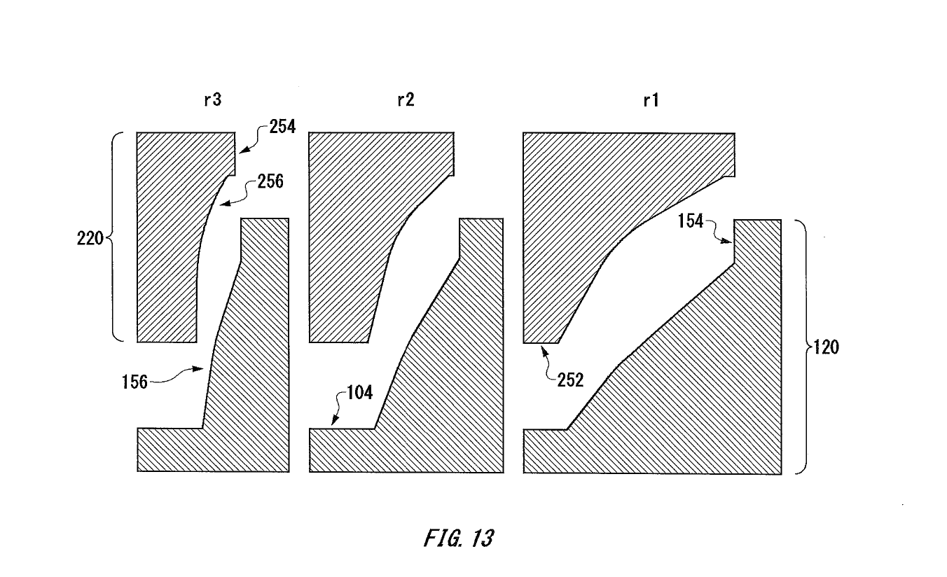

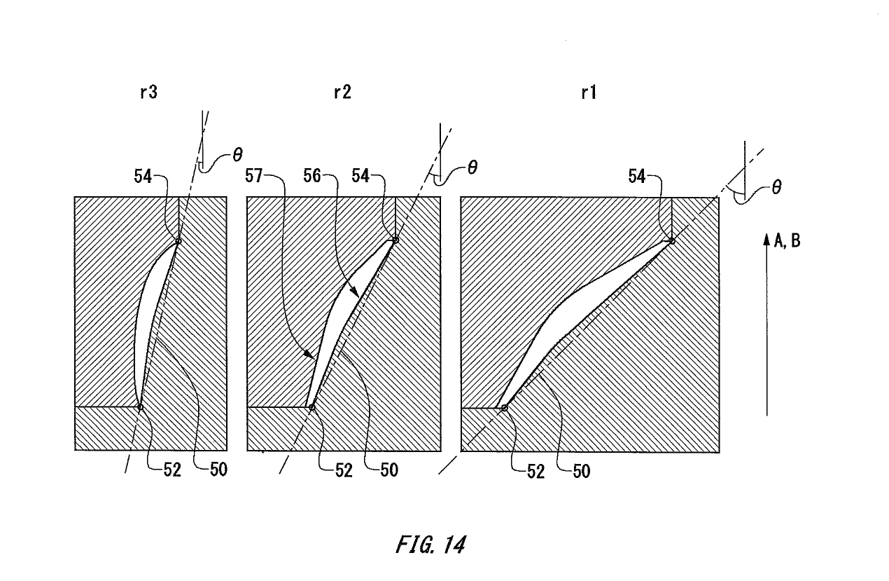

FIG. 13 illustrates how the first and second air-guide forming portions 120 and 220 are positioned relative to each other when the lower and upper molds 100 and 200 relating to the present example are separated from each other. FIG. 14 illustrates the space formed by the first and second air-guide forming portions 120 and 220 when the lower and upper molds 100 and 200 relating to the present example abut each other. FIGS. 13 and 14 illustrate the first and second air-guide forming portions 120 and 220 in cross section along a cylindrical surface defined as the outer circumferential surface of the circular cylinder that is centered on the axis A (or axis B), where the radius of the circular cylinder is varied from the distance between the axis A (or axis B) and a certain position to the radius of the outer wall 106 of the first base portion 102. Note that the cylindrical surface is developed into a plane. Here, the certain position is where the outer circumferential surface of the above-mentioned circular cylinder intersects with the curved surfaces 162 of the first protruding portions 150. FIGS. 13 and 14 each illustrate the cross-sections obtained when the radius of the circular cylinder is set at the values r1, r2 and r3, where r1 denotes the distance from the axis A (or axis B) to the position distant from the center of the circular cylinder, r3 denotes the distance from the axis A to the outer wall 106, and r2 denotes the distance from the axis A to the middle position between the position distant from the center of the circular cylinder and the outer wall 106.

According to the present example, the first curved surfaces 156 are shaped in the following manner. The angle θ formed with respect to the axial direction A by a first line 56 formed where the cylindrical surface intersects with each first curved surface 156 (that is to say, the line connecting together the points 52 and 54 in FIG. 14) decreases as the radius increases. To be specific, the angle θ has the smallest value when the radius is set equal to the distance from the axis A to the outer wall of the first base portion 102. According to the present example, the angle θ represents the angle formed with respect to the axial direction A by a straight line 50 connecting the respective ends of the line 56. The first line 56 formed by each first curved surface 156 and the cylindrical surface is convex in the upward direction with respect to the straight line connecting the respective ends of the line 56. On the other hand, a second line 57 formed by each second curved surface 256 and the cylindrical surface is convex in the upward direction with respect to the straight line connecting the respective ends of the second line 57. Therefore, the spaces created for forming the stator blades 17 have a wing-like shape. By supplying the appropriate material into the spaces created in the above-described manner, the air guiding surface 38 of each stator blade 17 is formed as a concave surface, and the surface of each stator blade 17 opposite to the air guiding surface 38 is formed as a convex surface. According to the present example, the first line 56 is defined as a line formed where the cylindrical surface intersects with at least one curved surface 156. According to a different example, however, the first line 56 may be defined as a line formed where a plane in contact with the outer circumferential surface of the circular cylinder intersects with at least one first curved surface 156. In this alternative case, the radius of the circular cylinder may be varied while one of the contact points between the outer circumferential surface and the plane moves along one of the two lines formed where the first and second curved surfaces 156 and 256 partially come into contact with each other. In the present example, these two lines are respectively represented by the points 52 and 54 in the cross-sectional views of FIG. 14.

According to the present example, each first curved surface 156 is formed in such a manner that the axial component of the first line 56 has a constant length when the radius is varied from r1 to r3. According to another example, however, each first curved surface 156 may be formed in such a manner that the length of the axial component of the first line 56 increases as the radius increases from r1 to r3. With such a configuration, the stator blades 17 can have higher strength.

As described earlier in the description about the housing 18, the angle θ may represent the angle formed between the tangent line to the line 56 and the axis A (or axis B). If such is the case, the angle θ may represent the angle formed between the axis A (axis B) and the tangent line at the end 52 (or the end 54). Alternatively, the angle θ may be defined as the average angle between the angle formed between the tangent line at the end 52 and the axis A (axis B) and the angle formed between the tangent line at the end 54 and the axis A (axis B). Alternatively, the angle θ may be defined as the average angle among angles each formed between the axis A (axis B) and a tangent line to the line 56 at a given point. Alternatively, the angle θ may indicate the angle formed between the axis A (axis B) and the tangent line to the line 56 at the midpoint of the axial component of the line 56. Alternatively, the angle θ may indicate the angle formed between the axis A (axis B) and the center line obtained by connecting together the respective ends 52 and 54 in such a manner that the center line has substantially the same distance from the first curved surface 156 and the second curved surface 256.

According to the present example, the first base portion 102 is substantially shaped like a circular cylinder, but the shape of the first base portion 102 is not limited to such. According to another example, the first base portion 102 may have a substantially pillar-like shape with the top surface 104 having a substantially symmetrical shape. Similarly, the second base portion 202 may have a substantially pillar-like shape with the top surface 204 having a substantially symmetrical shape.

Similarly, the support-member forming portion 210 is shaped like a circular cylinder in the present example, but may be formed like a pillar with the top surface having a substantially symmetrical shape in a different example. Here, the symmetrical shape may indicate a shape symmetrical with respect to a point, or a shape symmetrical with respect to a line. In more details, the symmetrical shape may be one of an equilateral triangle, a square, a rectangle, a rhombus, an ellipse, and an equilateral polygon.

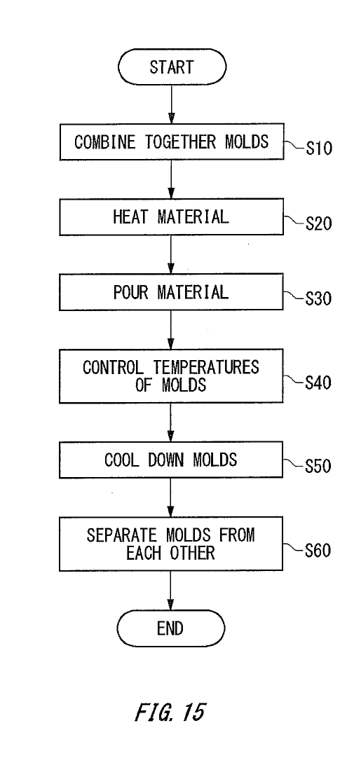

FIG. 15 illustrates a series of steps for forming a housing with the use of the four molds 100, 200, 300 and 400 relating to the present example. To begin with, the four molds are obtained and combined with each other (step S1). Specifically speaking, the lower and upper molds 100 and 200 are first combined with each other. After this, the right and left molds 300 and 400 are combined with each other so as to sandwich therebetween the combined lower and upper molds 100 and 200.

Subsequently, the material for forming the housing is heated (step S20), and the heated material is supplied into the spaces formed by the combined molds (step S30). According to the present example, the hole through which the material is supplied into the spaces (the sprue) is provided in one of the lower and upper molds 100 and 200. Such a hole may be provided in the center portion of the lower surface of the lower mold 100 which is substantially shaped like a circular cylinder, or in the center portion of the top surface of the upper mold 200 which is substantially shaped like a circular cylinder.

In the step S30, at least one of the rate at which the material is supplied, the pressure at which the material is supplied and the temperature of the material may be controlled. For example, the rate at which the material is supplied, the pressure at which the material is supplied and the temperature of the material may be varied depending on the properties of the material used. For example, as the viscosity of the material increases, the pressure at which the material is supplied may be increased, or the rate at which the material is supplied is decreased. Alternatively, the rate at which the material is supplied, the pressure at which the material is supplied and the temperature of the material may be varied depending on the complexity of the shapes of the molds. For example, in order that the material reliably and thoroughly reaches the spaces created for forming the plurality of stator blades 17, the material is supplied at a low rate and a high pressure in the beginning. After the material has reached the spaces created for forming the stator blades 17, the material may be supplied at a lower pressure or a higher rate.

Following this, the temperatures of the combined molds are controlled (step S40). In this case, the temperatures of the molds may be adjusted so as to be higher than or equal to the temperature of the heated material. Here, the temperature of at least one of the combined molds may be controlled. Alternatively, the temperature of a portion of the combined molds may be controlled. After the material has filled the spaces in the molds, the molds are cooled down (step S50). After this, the combined molds are separated from each other (step S60).

The housing 18 relating to the present example may be formed by using the injection molding technique. If such is the case, the material to be used is, for example, a polybutylene terephthalate (PBT) resin, an acrylonitrile butadiene styrene (ABS) resin, a polycarbonate (PC) resin, or the like. According to a different example, the housing may be formed by using the mold casting process. Alternatively, the housing may be formed by using the aluminum die casting process. The above-mentioned forming methods can manufacture the housing with a high dimensional accuracy.

What is claimed is:

1. A housing comprising:
a first hole forming portion defining a first hole;
a second hole forming portion defining a second hole which is opposite to the first hole, and being substantially symmetrical with respect to an axis of symmetry;
a channel forming portion having an inner wall which defines a channel and connecting the first and second hole forming portions to each other;
a support member arranged on the axis of symmetry; and
a plurality of air guiding portions arranged to connect the support member to at least a portion of the inner wall of the channel forming portion, the air guiding portions respectively having a plurality of air guiding surfaces capable of guiding air from the first hole forming portion to the second hole forming portion, wherein
each of the air guiding surfaces intersects with a cylindrical surface defined as an outer circumferential surface of a cylinder which is centered on the axis of symmetry and which has a radius from a radius of the support member to a radius of the inner wall of the channel forming portion, and
an angle of a first line at which one of the air guiding surfaces intersects with the cylindrical surface with respect to the axis is smallest when the one of the air guiding surfaces crosses the cylindrical surface on the inner wall of the channel forming portion.

2. The housing as set forth in claim 1, wherein the angle is an angle of a straight line connecting both ends of the first line with respect to the axis of symmetry.

3. The housing as set forth in claim 1, wherein each of the air guiding portions has a first edge and a second edge opposing the first edge, and
the first edge and the air guiding surface are entirely visible when the second hole forming portion is viewed along an axial direction parallel to the axis of symmetry.

4. The housing as set forth in claim 1, wherein the angle decreases as the radius of the cylinder increases from the radius of the support member to the radius of the inner wall of the channel forming portion.

5. The housing as set forth in claim 1, wherein a length of the first line in an axial direction parallel to the axis of symmetry increases as the radius of the cylinder increases from the radius of the support member to the radius of the inner wall of the channel forming portion.

6. The housing as set forth in claim 1, wherein a length of the first line in an axial direction parallel to the axis of symmetry is substantially constant as the radius of the cylinder increases from the radius of the support member to the radius of the inner wall of the channel forming portion.

7. The housing as set forth in claim 1, further comprising an expansion portion arranged on a side of the second hole forming portion opposite to the first hole forming portion and defining an opening connected to the second hole, wherein
an inner diameter of the expansion portion increases as the expansion portion moves away from the second hole forming portion in an axial direction parallel to the axis of symmetry.

8. The housing as set forth in claim 7, wherein the expansion portion is substantially rectangular when viewed along the axial direction, and
the opening defined by the expansion portion has a shape gradually changing from a shape of the second hole to a substantially rectangular shape.

9. The housing as set forth in claim 8, wherein the air guiding portions are connected to at least a portion of the expansion portion.

10. The housing as set forth in claim 1, wherein each of the first and second holes is substantially circular.

11. The housing as set forth in claim 1, wherein the support member is substantially symmetrical, and
the air guiding portions are arranged on the support member at substantially regular intervals such that each of the air guiding portions connects the support member to the inner wall of the channel forming portion.

12. The housing as set forth in claim 1, wherein the angle of the first line at which each of the air guiding surfaces intersects with the cylindrical surface with respect to the axis is smallest when that air guiding surface intersects with the cylindrical surface on the inner wall of the channel forming portion.

13. A fan device comprising:
the housing as set forth in claim 1;
an impeller having a plurality of rotating blades rotatable about a rotation axis to create an air flow flowing along the rotation axis; and
a motor driving the impeller, wherein
the impeller and the motor are accommodated in the housing from the first hole, and
the support member supports the motor.

14. The fan device according to claim 13, wherein a number of the rotating blades is different from a number of the air guiding portions.

15. The fan device according to claim 14, wherein the number of the rotating blades is a prime number.

16. A mold used for forming a housing having a plurality of air guiding portions, the mold comprising a first mold and a second mold to be combined with each other, wherein
the first mold comprises:
a substantially columnar first base portion having a top surface which is substantially symmetrical with respect to an axis of symmetry; and
a plurality of first protruding portions protruding from the top surface of the first base portion in an axial direction parallel to the axis of symmetry, the first protruding portions being arranged about the axis of symmetry at substantially regular circumferential intervals and spaced away from the axis of symmetry, and
each of the first protruding portions includes a first air-guide forming portion connected to the top surface of the first base portion and a first engaging portion connected to an upper portion of the first air-guide forming portion, the first engaging portion has a first contact surface intersecting with a top surface of a corresponding one of the first protruding portions and being substantially parallel to the axial direction, the first air-guide forming portion has a first curved surface connected to the first contact surface and intersecting with the top surface of the corresponding one of the first protruding portions, and
the second mold includes:
a substantially columnar second base portion having a top surface which is substantially symmetrical with respect to another axis of symmetry; and
a support-member forming portion arranged along the other axis of symmetry of the second base portion and having a substantially flat top surface; and
a plurality of second protruding portions protruding from the top surface of the second base portion along the other axis of symmetry and each being received in a space between adjacent ones of the first protruding portions on the first base portion, the second protruding portions connected to the support-member forming portion and being arranged about the other axis of symmetry at substantially regular circumferential intervals and spaced away from the other axis of symmetry, and
each of the second protruding portions includes a second engaging portion connected to the second base portion and a second air-guide forming portion connected to an upper portion of the second engaging portion, the second engaging portion has a second contact surface intersecting with the top surface of the base portion and being substantially parallel to the other axis of symmetry, and the second air-guide forming portion has a second curved surface connected to the second contact surface and intersecting with a top surface of a corresponding one of the second protruding portions, and
when the first and second molds are combined with each other with the axes of symmetry of the first and second base portions coincident with each other and the top surface of each of the first protruding portions facing the top surface of each of the second protruding portions, the support-member forming portion of the second mold is received in a space formed near the axes of symmetry by two or more of the first protruding portions;
the first contact surface comes into contact with the second contact surface; the top surfaces of the first protruding portions come into contact with the top surfaces of the second protruding portions; and the top surfaces of the second protruding portions come into contact with the top surface of the first base portion, thereby defining a plurality of spaces for forming the air guiding portions of the housing by the first curved surfaces of the first air-guide forming portions and the respective second curved surfaces of the second air-guide forming portions, and
an angle, with respect to the axes of symmetry coincident with each other, of a first line at which one of the first curved surfaces intersects with a cylindrical surface as an outer circumferential surface of a cylinder centered about the axes of symmetry, is smallest when a radius of the cylinder is substantially equal to an radius of an outer wall of the first base portion.

17. The mold as set forth in claim 16, wherein the angle is an angle of a straight line connecting both ends of the first line with respect to the axes of symmetry coincident with each other.

18. The mold as set forth in claim 16, wherein the angle decreases as the radius of the cylinder increases to the radius of the outer wall of the first base portion.

19. The mold as set forth in claim 16, wherein a length of the first line in an axial direction parallel to the axes of symmetry coincident with each other increases as the radius of the cylinder increases to the radius of the outer wall of the first base portion.

20. The mold as set forth in claim 16, wherein a length of the first line in an axial direction parallel to the axes of symmetry coincident with each other is substantially constant as the radius of the cylinder increases to the radius of the outer wall of the first base portion.

21. The mold as set forth in claim 17, wherein the support-member forming portion is substantially columnar.

22. The mold as set forth in claim 16, wherein the first base portion is substantially columnar, and includes a first expansion portion in which a diameter of the first base portion increases as the first base portion moves away from its top surface along the axis of symmetry of the first base portion.

23. The mold as set forth in claim 22, wherein the second base portion is substantially columnar, and includes a second expansion portion in which a diameter of the second base portion increases as the second base portion moves away from its top surface along the axis of symmetry of the second base portion.

24. The mold as set forth in claim 23, further comprising a third mold and a fourth mold which are to be combined to surround the combined first and second molds by at least a portion of each of the first and second expansion portions of the combined first and second molds, each of the third and fourth molds being substantially symmetrical.

25. The mold as set forth in claim 24, wherein a space defined by inner walls of the third and fourth molds and outer walls of the combined first and second molds is connected to the plurality of spaces defined by the first curved surfaces of the first air-guide forming portions of the first mold and the second curved surfaces of the second air-guide forming portions of the second mold.

26. A method of forming a housing by means of the mold as set forth in claim 25, comprising:
combining the first and second molds with each other;
heating material of the housing;
supplying the heated material into a space defined in the combined first and second molds; and
separating the combined first and second molds from each other.

27. The method as set forth in claim 26, the supplying of the material includes controlling at least one of a supplying rate of the material, a supplying pressure of the material, and a temperature of the material.

28. The method as set forth in claim 26, further comprising controlling a temperature of the combined first and second molds.

29. The method as set forth in claim 28, wherein the controlling of the temperature of the combined first and second molds includes controlling a temperature of at least one of the combined first and second molds.

30. The method as set forth in claim 28, wherein the controlling of the temperature of the combined first and second molds includes controlling a temperature of a portion of the combined first and second molds.
